(19) United States
(12) Patent Application Publication
(10) Pub. No.: US 2024/0015544 A1
(43) Pub. Date: Jan. 11, 2024

(54) MULTI-LINK MEASUREMENT REPORTING

(71) Applicant: Telefonaktiebolaget LM Ericsson (publ), Stockholm (SE)

(72) Inventors: Jonas SEDIN, Brentford Greater London (GB); Abhishek AMBEDE, Huddinge (SE); Miguel LOPEZ, Aachen (DE)

(21) Appl. No.: 18/252,466

(22) PCT Filed: Nov. 25, 2021
(86) PCT No.: PCT/EP2021/083068

§ 371 Date: May 10, 2023

Related U.S. Application Data
(60) Provisional application No. 63/119,149, filed on Nov. 30, 2020.

(51) Int. Cl. H04W 24/08; H04W 24/10

(52) U.S. Cl. CPC H04W 24/08; H04W 24/10

(57) ABSTRACT

A first wireless device (WD) configured to communicate with a second WD is provided. The first WD is configured to, and/or includes a radio interface and/or includes processing circuitry configured to receive a request for a communication measurement, perform the communication measurement based at least on the received request, and transmit a measurement report. The measurement report includes at least the performed communication measurement. Methods and other apparatuses are also disclosed.

### FIELD

The present disclosure relates to wireless communications, and in particular, to multi-link measurement reporting.

### INTRODUCTION

Radio Measurements in IEEE 802.11

Wireless communication networks, such as those provided based on standards promulgated by the Institute of Electrical and Electronics Engineers (IEEE), e.g., Wireless Local Area Networks (WLANs) supporting IEEE 802.11 protocols, typically benefit from the ability to request and report radio measurements. Generally, a radio measurement framework is used to aid a WLAN, in terms of operation and management, by measuring quantities such as received signal strength indicator (RSSI), service load, power state, and other operating conditions, such as noise histograms, from the perspective of a station (STA). By reporting these measurements to a requesting STA, a better understanding of the operating conditions of the STAs can allow for load balancing, changing the channel to a less interfered channel, and adjusting link adaption.

According to IEEE 802.11, an STA can request another STA to perform radio measurements through requesting and reporting. The STA that receives a measurement request may also refuse the request. The following are some examples of radio measurement reports: (1) Beacon report and Frame report, which includes signal strength of a beacon or a frame; (2) Channel Load Report, which includes the load on a channel, e.g., a measure of a fraction of time for which a channel remains busy; (3) Noise Histogram Report, which includes a measured noise power and interference, e.g., Idle Power Indicator (IPI), signaled as a histogram; and (4) STA statistics report, which includes STA statistics, such as a number of medium access control service data units (MSDUs) received during a requested time instance.

The STA can either be requested to measure in an operating channel or a non-operating channel. In cases where the STA is requested to measure in a non-operating channel, the STA may have to momentarily cancel (or pause) data traffic transmission or reception in order to fulfill the request. An STA could, however, refuse the measurement request, but the STA is then required to report back that the STA is refusing to perform the measurement. FIG. 1 shows a typical process of measurement frame exchange between two STAs, i.e., STA1 and STA2.

Multi-Link in 802.11be

The next-generation major amendment to the IEEE 802.11 WLAN standard, which is currently under development, is IEEE 802.11be, also termed as Extremely High Throughput (EHT). EHT introduces a new key feature called multi-link (ML). In ML, a device termed as ML device (MLD) has multiple affiliated STAs, each of which can communicate using independent wireless channels/links. Communication over multiple links by an MLD is termed as multi-link operation (MLO). For example, an MLD can have two affiliated STAs, one STA communicating using channels in a 5 GHz frequency band, and the other STA communicating using channels in a 6 GHz frequency band. In another example, an MLD can have two affiliated STAs, each STA communicating using channels in the 6 GHz frequency band.

An MLD can use affiliated STAs and corresponding supported channels to perform simultaneous transmit (TX) MLO, simultaneous receive (RX) MLO, or simultaneous TX and RX (STR) MLO to manage throughput and latency performance, as well as spectrum utilization. An MLD trying to perform STR MLO may face severe cross-channel self-interference (SI) problems due to leakage from TX to RX channels. Cross-channel SI signal power in a RX channel can be in orders of magnitude higher than the power of a desired signal, thereby affecting reception/sensing ability of an RX chain.

If an MLD can perform STR over a supported pair of channels by tackling or without facing the cross-channel SI problem, that pair of channels is classified as STR. However, if transmitting over one channel results in inability to simultaneously receive over another channel, the supported pair of channels is classified as non-STR (NSTR). An MLD may announce STR capability related to a pair of supported channels. Simultaneous TX and simultaneous RX MLOs over NSTR pair of channels require that transmissions over the two channels are synchronized to some extent, e.g., time-alignment to prevent occurrence of STR and thus cross-channel SI. However, this synchronization may put rather strict requirements while executing such MLOs.

An access point (AP) MLD may be defined as an MLD with two or more AP STAs, whereas a non-AP MLD may be defined an MLD with two or more affiliated non-AP STAs. An AP MLD can perform simultaneous downlink (DL) MLO or simultaneous uplink (UL) MLO involving non-AP STAs. Additionally, an AP MLD that can perform STR MLO over two channels can also perform simultaneous DL and UL MLO where different types of frames can be independently transmitted and received over these channels.

Multi-Link Architecture and Addressing

From a higher-layer, i.e., open system interconnection layer, perspective in a typical ML architecture is as shown in FIG. 2, the MLD still appears as a single device despite several links on different bands. This means that there is a single MAC-Service Access Point (MAC-SAP) and that there is only one logical association between an AP and a non-AP.

FIG. 2 shows an example of an ML architecture, where a Legacy STA is at 2.4 GHz and is compared with an MLD that has one link at 2.4 GHz and another at 5.0 GHz. One issue with this architecture is related to addressing, given the separation described above. Addressing in an MLD works by each link having their own separate MAC addresses per link and a separate MAC address that is per-MLD to address the MLD.

According to one measurement procedure, a subclause describes radio measurements and procedures for requesting and reporting radio measurements between STAs. In ML, a STA is only a part of a general device known as an MLD, which comprises multiple STAs. Thus, ordering and STA to take an action does not make clear what specific STA within in the MLD is expected to perform the action. On the other hand, if the MLD is ordered to perform a measurement, then there may be confusion regarding which STA within the MLD is requested perform the measurement.

Furthermore, if an STA is requested to measure on a non-operating channel, then measurements on non-operating channels might need the measuring STA to interrupt data services on an operating channel, switch channels, and make measurements. In other words, if an STA is ordered to measure on a non-operating channel, the STA (or MLD) switches channel and momentarily stops receiving and/or transmitting on that channel/link, which can cause significant disruption of data transmissions. For example, this disruption may occur if the majority of throughput is carried in one link in an MLD, and the STA on that link is requested to perform measurements.

Another issue with existing measurement processes arises when measurements are requested and reported per STA. In this case, the MLD that requests a measurement would have to send measurement requests to every STA within the reporting MLD, potentially causing inefficiencies.

### SUMMARY

Some embodiments advantageously provide methods, systems, and apparatuses for multi-link measurement requesting and reporting. Aspects of the invention are provided by the appended independent claims, and embodiments thereof are provided by the dependent claims.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 shows a typical process of measurement frame exchange between two STAs;

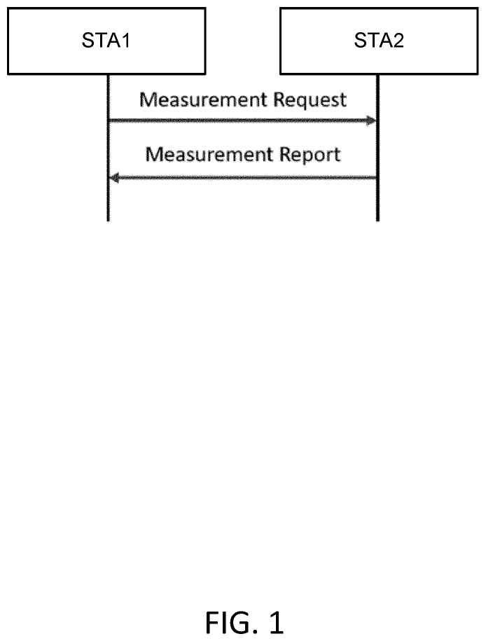

FIG. 2 shows a typical multi-link architecture including a legacy STA at 2.4 GHz and an MLD that has one link at 2.4 GHz and another at 5.0 GHz.

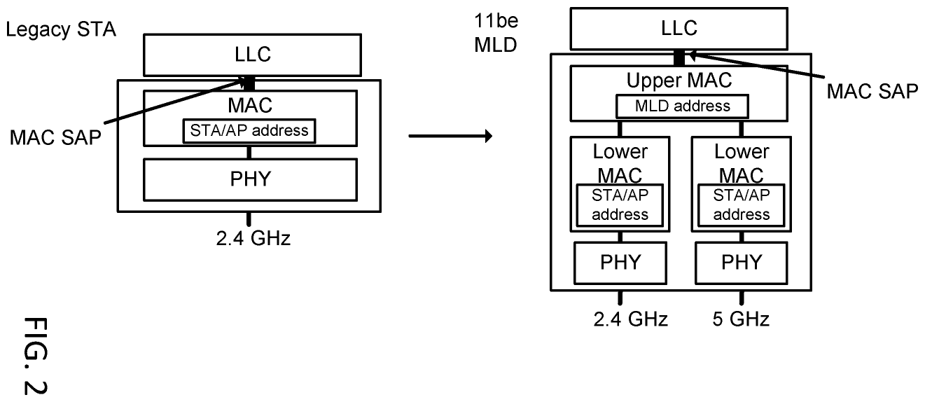

FIG. 3 is a block diagram of a first wireless device in communication with a second wireless device over an at least partially wireless connection according to some embodiments of the present disclosure;

FIG. 4 is a flowchart of an example process in a first wireless device for multi-link measurement reporting according to some embodiments of the present disclosure;

FIG. 5 is a flowchart of an example process in a second wireless device for multi-link measurement processing according to some embodiments of the present disclosure;

FIG. 6 is an example process for multi-link measurement reporting utilizing STA-level measurement frame exchange according to some embodiments of the present disclosure;

FIG. 7 is an example process of measurement reporting utilizing single measurement frame and/or multiple aggregated single measurement frames according to some embodiments of the present disclosure; and

FIG. 8 is an example process for multi-link measurement reporting utilizing MLD-level measurement frame exchange according to some embodiments of the present disclosure.

### DETAILED DESCRIPTION

In some embodiments, a method at a wireless device (WD) is provided. The WD may include an MLD and/or STAs for performing radio measurements by considering a measurement request received at either STA-level and/or MLD-level, transmitting a measurement report at STA-level or MLD-level, allowing for any or specific STAs to perform measurements, and/or allowing for multiple measurements to be requested. In other words, ML capabilities are utilized to perform radio measurements and to perform reporting.

In some other embodiments, since a set of processes on MAC-level is performed per STA/link, such as a construction of an Aggregated MAC Protocol Data Unit (PDU), and a set of processes is performed per-MLD level, Upper and Lower MAC is considered, where there is a single Upper MAC per MLD and multiple Lower MACs per MLD, one for each link. The terms “channels” and “links” are used interchangeably in the present disclosure.

Before describing in detail exemplary embodiments, it is noted that the embodiments reside primarily in combinations of apparatus components and processing steps related to multi-link measurement reporting Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc. Although embodiments relating to STAs are described with respect to WDs, it is understood that implementations and embodiments where the STA is a network node are also contemplated. In other words, the disclosure is not limited to STAs being only WDs. STAs can also be network nodes within the context of the disclosure.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein. Some embodiments provide for, in a multi-link environment, requesting a communication measurement and for reporting a measurement report that includes the requested communication measurement.

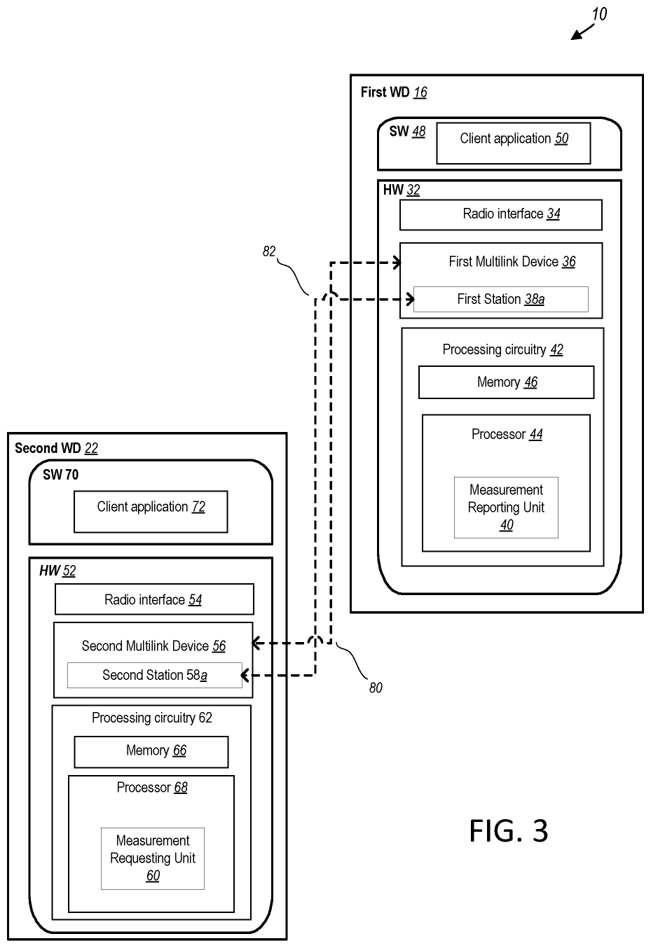

Referring now to the drawing figures, in which like elements are referred to by like reference numerals, there is shown in FIG. 3 an example of block diagram of a communication system 10 comprising first wireless device in communication with a second wireless over an at least partially wireless connection according to an embodiment, such as a WLAN that may support standards such as IEEE 802.11.

A first WD 16 is configured to include a measurement reporting unit 40 which is configured to provide multi-link measurement reporting. The second WD 22 is configured to include a measurement requesting unit 60 which is configured to request multi-link measurement reporting. However, the first WD 16 is not limited to including only a measurement reporting unit 40 and may also, or in the alternative, include a measurement requesting unit 60 as included in the second WD 22. Similarly, the second WD 22 is not limited to including only a measurement requesting unit 60 and may also, or in the alternative, include a measurement requesting unit 40 as included in the first WD 22.

The first WD 16 provided in a communication system 10 includes hardware 32 enabling it to communicate with the second WD 22. The hardware 32 may include a radio interface 34 for setting up and maintaining a wired or wireless connection with an interface of a different communication device of the communication system 10, as well as a first multi-link device 36 for setting up and maintaining at least a wireless connection 80 with the second WD 22 and/or with a different communication device of the communication system. The first multi-link device 36 may include at least a first station 38a for setting up and maintaining at least a wireless connection 82 with a second WD 22 and/or with a different communication device of the communication system. The first multi-link device 36 may include more than one first station 38. The radio interface 36 and/or the first multi-link device 38 and/or the first station 38 may be formed as or may include, for example, one or more RF transmitters, one or more RF receivers, and/or one or more RF transceivers.

In the embodiment shown, the hardware 32 of the first WD 16 further includes processing circuitry 42. The processing circuitry 42 may include a processor 44 and a memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) the memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the first WD 16 further has software 48 stored internally in, for example, memory 46, or stored in external memory (e.g., database, storage array, network storage device, etc.) accessible by the first WD 16 via an external connection. The software 48 may be executable by the processing circuitry 42. The software 48 may include a client application 50. The client application 50 may be operable to provide a service to a human or non-human user via the first WD 22. The client application 50 may interact with the user to generate the user data that it provides.

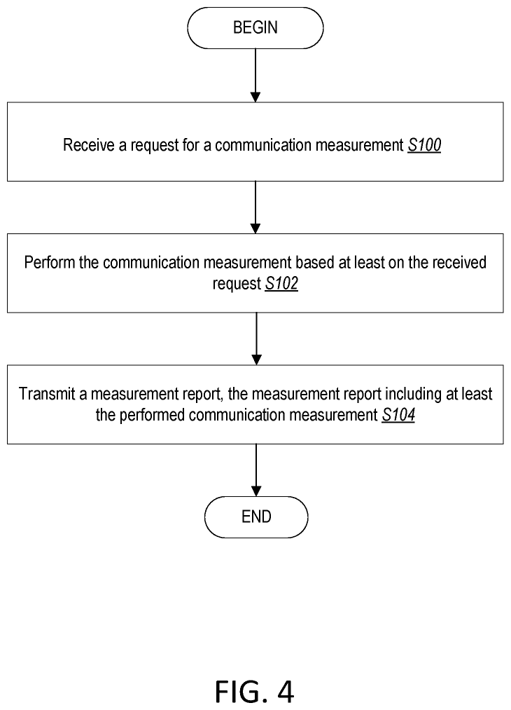

The processing circuitry 42 may be configured to control any of the methods and/or processes described herein and/or to cause such methods, and/or processes to be performed, e.g., by first WD 16. Processor 44 corresponds to one or more processors 44 for performing first WD 16 functions described herein. The memory 46 is configured to store data, programmatic software code and/or other information described herein. In some embodiments, the software 48 may include instructions that, when executed by the processor 44 and/or processing circuitry 42, causes the processor 44 and/or processing circuitry 42 to perform the processes described herein with respect to first WD 16. For example, processing circuitry 42 of the first WD 16 may include measurement reporting unit 40 configured to perform the first WD methods discussed herein, such as the methods discussed with reference to FIG. 4 as well as other figures.

In some embodiments, the processing circuitry 42 of the first WD 16 may be configured to use resources and/or receive and/or transmit on radio resources (e.g., physical layer resources, such as, frequency channel, resource units, etc.) that are allocated to the first WD 16.

The second WD 22 provided in a communication system 10 includes hardware 52 enabling it to communicate with the first WD 16. The hardware 52 may include a radio interface 54 for setting up and maintaining a wired or wireless connection with an interface of a different communication device of the communication system 10, as well as a second multi-link device 56 for setting up and maintaining at least a wireless connection 80 with the first WD 16 and/or with a different communication device of the communication system. The second multi-link device 56 may include at least a first station 58a for setting up and maintaining at least a wireless connection 82 with the first WD 16 and/or with a different communication device of the communication system. The second multi-link device 56 may include more than one first station 58. The radio interface 54 and/or the second multi-link device 56 and/or the second station 58 may be formed as or may include, for example, one or more RF transmitters, one or more RF receivers, and/or one or more RF transceivers. The hardware 52 of the second WD 22 further includes processing circuitry 62. The processing circuitry 62 may include a processor 68 and memory 66. In particular, in addition to or instead of a processor, such as a central processing unit, and memory, the processing circuitry 62 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 68 may be configured to access (e.g., write to and/or read from) memory 66, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the second WD 22 may further comprise software 70, which is stored in, for example, memory 66 at the second WD 22, or stored in external memory (e.g., database, storage array, network storage device, etc.) accessible by the second WD 22. The software 70 may be executable by the processing circuitry 62. The software 70 may include a client application 72. The client application 72 may be operable to provide a service to a human or non-human user via the second WD 22. The client application 72 may interact with the user to generate the user data that it provides.

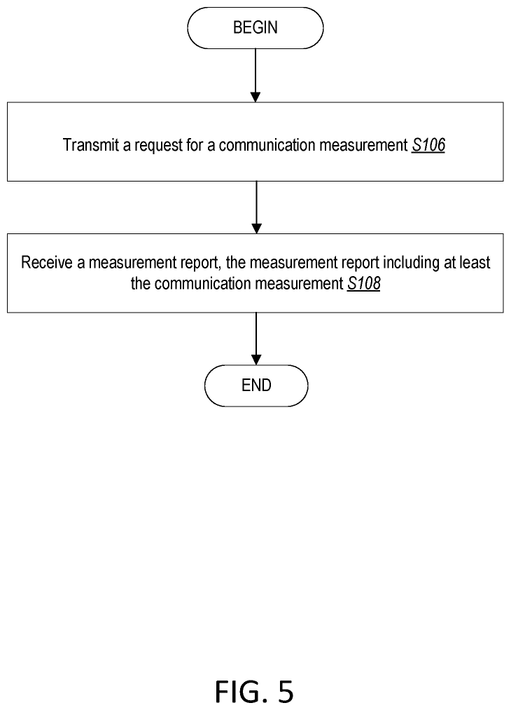

The processing circuitry 62 may be configured to control any of the methods and/or processes described herein and/or to cause such methods, and/or processes to be performed, e.g., by the second WD 22. The processor 68 corresponds to one or more processors 68 for performing the second WD 22 functions described herein. The second WD 22 includes memory 68 that is configured to store data, programmatic software code and/or other information described herein. In some embodiments, the software 70 and/or the client application 72 may include instructions that, when executed by the processor 68 and/or processing circuitry 62, causes the processor 68 and/or processing circuitry 62 to perform the processes described herein with respect to second WD 22. For example, processing circuitry 62 of the second WD 22 may include measurement requesting unit configured to perform wireless device methods discussed herein, such as the methods discussed with reference to FIG. 5 as well as other figures.

In some embodiments, the processing circuitry 62 of the second WD 22 may be configured to use resources and/or receive and/or transmit on radio resources (e.g., physical layer resources, such as, frequency channel, resource units, etc.) that are allocated to the second WD 22.

Although FIG. 3 shows various “units” such as each of measurement reporting unit 40 and measurement requesting unit 60 as being within a processor, it is contemplated that these units may be implemented such that a portion of the unit is stored in a corresponding memory within the processing circuitry. In other words, the units may be implemented in hardware or in a combination of hardware and software within the processing circuitry.

FIG. 4 is a flowchart of an example method for a first WD 16 to provide multi-link measurement reporting according to some embodiments of the present disclosure. One or more Blocks and/or functions and/or methods performed by the first WD 16 may be performed by one or more elements of the first WD 16, such as by measurement reporting unit 40 in processing circuitry 42, processor 44, radio interface 34, first multi-link device 36, first station 38a, according to the example method. The example method includes receiving (Block S100), such as via measurement reporting unit 40 in processing circuitry 42, processor 44, radio interface 34, first multi-link device 36, first station 38a, a request for a communication measurement. In addition, the method includes performing (Block S102), such as via measurement reporting unit 40 in processing circuitry 42, processor 44, radio interface 34, first multi-link device 36, first station 38a, the communication measurement based at least on the received request. The method further includes transmitting (Block S104), such as via measurement reporting unit 40 in processing circuitry 42, processor 44, radio interface 34, first multi-link device 36, a measurement report, the measurement report including at least the performed communication measurement.

In some embodiments, the first WD 16 includes a first multi-link device (MLD) 36, the first MLD 36 including a first plurality of stations (STAs) 38. In other embodiments, the request for the communication measurement is received by an STA 38a of the first plurality of STAs 38, the STA 38a being a single-link device, and the measurement report is transmitted by the STA 38a. In another embodiment, the communication measurement is performed by one of the STA 38a, another STA of the first plurality of STAs 38 that is available to perform the communication measurement and is different from the STA 38a, and at least one predetermined STA of the plurality of STAs 38.

In other embodiments, the communication measurement includes one of a single measurement performed on a single communication link and a plurality of measurements. Each measurement of the plurality of measurements is performed on a different communication link. In some other embodiments, the measurement report is transmitted in one of a single measurement report frame and a plurality of measurement report frames.

In another embodiment, the request for the communication measurement is received by the first MLD 36, the measurement report is transmitted by the first MLD 36, and the communication measurement is performed by one of an STA 38, an STA of the first plurality of STAs 38 that is available to perform the communication measurement, and at least one predetermined STA of the plurality of STAs 38. In some embodiments, the method further includes transmitting a refusal to perform the communication measurement.

FIG. 5 is a flowchart of an example method for a second WD 22 to provide multi-link measurement processing according to some embodiments of the present disclosure. One or more Blocks and/or functions and/or methods performed by the second WD 22 may be performed by one or more elements of the second WD 22, such as by measurement requesting unit 60 in processing circuitry 62, processor 68, radio interface 54, second multi-link device 56, second station 58a, according to the example method. The example method includes transmitting (Block S106), such as via measurement requesting unit 60 in processing circuitry 62, processor 68, radio interface 54, second multi-link device 56, second station 58a, a request for a communication measurement. The method further includes receiving (Block S108), such as via measurement reporting unit 40 in processing circuitry 42, processor 44, radio interface 34, first multi-link device 36, a measurement report, the measurement report including at least the communication measurement.

In some embodiments, the second WD 22 includes a second multi-link device (MLD) 56, the second MLD 56 including a second plurality of stations (STAs) 58. In other embodiments, the request for the communication measurement is transmitted by an STA of the second plurality of STAs 58, and the measurement report is received from an STA 38 of the first WD 16, the STA 38 of the first WD 16 being a single-link device. In another embodiment, the communication measurement includes one of a single measurement performed on a single communication link and a plurality of measurements, each measurement of the plurality of measurements being performed on a different communication link.

In some other embodiments, the measurement report is received in one of a single measurement report frame and a plurality of measurement report frames. In another embodiment, the request for the communication measurement is transmitted by the second MLD 56 and the measurement report is received by the second MLD 56. In some embodiments, the method further includes receiving a refusal to perform the communication measurement.

Having described the general process flow of arrangements of the disclosure and having provided examples of hardware and software arrangements for implementing the processes and functions of the disclosure, the sections below provide details and examples of arrangements for multi-link measurement reporting.

Some embodiments provide methods and apparatuses for requesting radio measurements in a multi-link environment and providing measurement reporting.

STA-Level Report and Requesting of Measurements

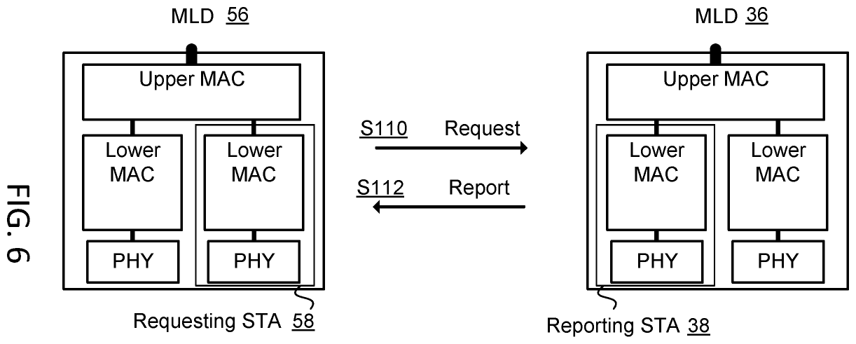

Turning to FIG. 6, which shows an example of reporting and requesting for measurements that are performed on an STA-basis. At step S110, the requesting STA 58 in MLD 56 transmits a request for a communication measurement to the reporting STA 38 in MLD 36. At step S112, the reporting STA 38 transmits a measurement report to the requesting STA 58.

More specifically, the STA 38 that is receiving the measurement request (S110) may be a single-link device, even though STA 38 is affiliated with MLD 36. In other words, the measurements that take place are performed by STA 38 within MLD 36. After the measurement is performed, the STA 38 within the MLD 36 reports back (S112) the measurement to the requesting STA 58. According to this example, the STA that is to perform the measurement is the STA 38 that receives the request for measurement.

In another embodiment, the STA 38 that is receiving the measurement request, will also report back the measurement, but the measurement can be performed by any available STA within the MLD 36, which allows data transmissions performed by STA 38 to continue on the same link, i.e., without causing interruptions so that STA 38 can perform measurements. In some other embodiments, links that are inactive, e.g., due to power saving or not enough data, may be utilized to perform measurements. An inactive link can be activated before commencement of measurements, e.g., first starting transmissions on the link then requesting to perform measurements on the link. In addition, multiple measurements may also be requested.

According to another embodiment, a requesting STA 58 may also request that a measurement is performed by a specific STA 38 or specific STAs, e.g., in case of requesting multiple measurements. For example, a requesting STA 58 may request to have control of links that are active, e.g., when continuous data transmissions are occurring and the requesting STA would not like that a well-performing link that is being used to perform data transmissions to momentarily stop transmitting to perform measurements. Alternatively, an STA 38 may refuse a measurement request if the STA 38 that was requested to perform the measurement is unavailable. According to a non-limiting example, a refusal message, e.g., transmitted by STA 38, may contain information regarding which alternative STA within MILD 36 may be available. For example, when an STA 38 receives a measurement request that requests that same STA 38 to perform the measurement, other STAs that are available may perform measurements.

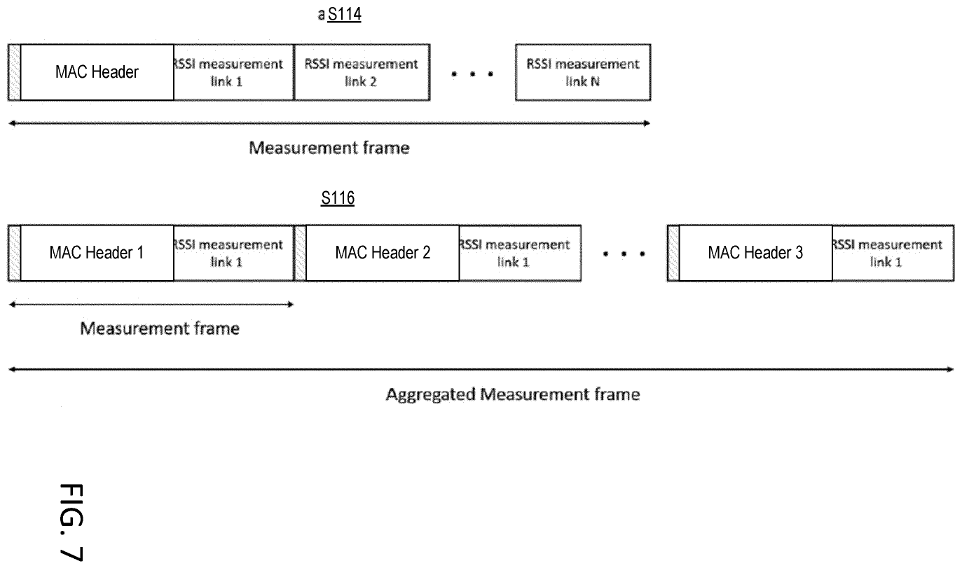

Transmitting a measurement report may be performed in a variety of ways. FIG. 7 shows examples of transmissions of measurement reports. At step S114, a single measurement frame may be used for all communication links. At step S116, multiple single measurement frames are aggregated.

A measurement report may be transmitted by the STA 38 that received the measurement request within the MLD 36. If there have been measurements that have been generated on multiple links, at step S114, all of the measurements will be included in a single measurement report frame. Alternatively, at step S116, a single measurement report frame is generated for each measurement on each link. In one embodiment, the measurement report frame can be aggregated in an Aggregate MAC Protocol Data Unit (A-MPDU) along with normal data transmissions. In some other embodiments, the measurement report frame(s) are transmitted in a single A-MPDU.

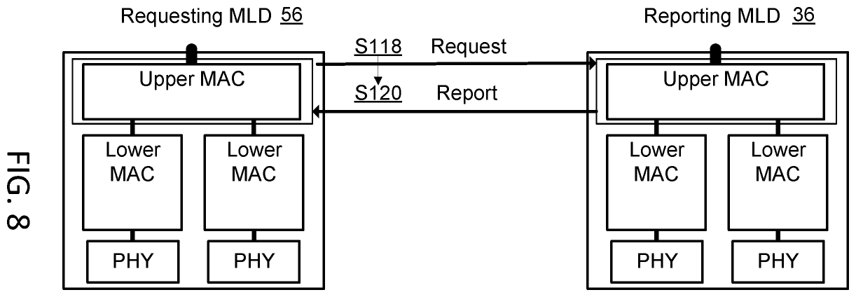

MLD-level Report and Requesting of Measurements Reporting and requesting for measurements may performed on an MLD-level, i.e., performing measurement(s) is independent of which STA receives a measurement request. FIG. 8 shows an example MED-level measurement frame exchange. At step S118, requesting MLD 56 transmits a request for a communication measurement to reporting MLD 36. At step S120, the reporting MLD 36 transmits a measurement report to the requesting MLD 56. More specifically, the reporting MLD 36 will only be requested to perform a measurement and may then use any STA 38 to perform that measurement. According to some embodiments, the reporting MLD 36 may be requested to perform measurements on multiple bands/frequencies and transmit a measurement report including the requested measurements. According to another embodiment, all available STAs 38 or STAs 38 that are not busy may perform the measurement and/or report the measurements. STAs that are not available/busy may be indicated in the measurement report.

In another embodiment, the reporting MLD 36 will be requested to perform a measurement using a specific STA 38 or multiple specific STAs 38. The MLD 36 may also transmit a report that includes information that indicates if any of the specific STAs are refusing to perform the requested measurement. In yet another embodiment, the reporting MLD 36 may be requested to perform a measurement on all STAs, e.g., active and possibly inactive STAs.

In terms of refusing measurements, in one embodiment, if MLD 36 is asked to perform measurements over multiple channels and the MLD 36 is unable to perform the measurements within a predetermined amount of time, e.g., performing measurements on a predefined amount of links within time t, then the MLD 36 may refuse certain measurements, e.g., single measurements, and only report some measurements. The refusal may be performed transmitting a refusal message and/or a refusal flag. The refusal may be included with the performed measurements when the measurements are reported.

Multiple measurements may also be requested. An MLD that requests another MLD to perform measurements may include a request for measurements that may be performed if the MILD receiving the request supports such measurements. According to a non-limiting example, the receiving MLD 36 may determine that a quality of service (QoS), e.g., latency or throughput, of certain traffic can be maintained.

Further, a measurement report can be transmitted by any STA 38 in the MLD 36 and optionally be aggregated with data transmissions. In a non-limiting example where multiple measurements have been performed for a measurement report, a single measurement report frame may be created and/or transmitted for all of links. In addition, multiple measurement report frames may be generated as shown in FIG. 7.

### SOME EXAMPLE EMBODIMENTS

According to an aspect, processes and/or devices for requesting measurements, performing measurements and reporting measurements are provided. Initially, a requesting device transmits (x01) a measurement request. A reporting device receives (x02) the measurement request. A device performs (x03) at least one measurement. A reporting device transmits (x04) a measurement report. In some embodiments, the reporting devices (x02), (x03) and (x04) may be considered devices with a single link. In general, STA is a single radio consisting of physical layer, PHY, and lower medium access control, MAC, layer part. MLD comprises of multiple STAs, aggregated through upper MAC layer part. In some other embodiments, the reporting devices (x02) and (x04) may be considered an STA, but the device that performs the measurement (x03) can be any STA. In some other embodiments, the reporting devices (x02) and (x04) consider a message, such as a measurement request and/or a measurement report, as received and/or transmitted at MLD-level. In another embodiment, the measurement device (x03) can be any device. In some embodiments, the requesting device can request a specific device to perform the measurement in (x03).

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and sub-combination of these embodiments. Accordingly, all embodiments can be combined in any way and/or combination, and the present specification, including the drawings, shall be construed to constitute a complete written description of all combinations and sub-combinations of the embodiments described herein, and of the manner and process of making and using them, and shall support claims to any such combination or sub-combination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

### EMBODIMENTS

Embodiment A1. A first wireless device (WD) configured to communicate with a second WD, the first wireless device configured to, and/or comprising a radio interface and/or comprising processing circuitry configured to:
receive a request for a communication measurement;
perform the communication measurement based at least on the received request; and
transmit a measurement report, the measurement report including at least the performed communication measurement.

Embodiment A2. The first WD of Embodiment A1, wherein the first WD includes a first multi-link device (MLD), the first MLD including a first plurality of stations (STAs).

Embodiment A3. The first WD of Embodiment A2, wherein the request for the communication measurement is received by an STA of the first plurality of STAs, the STA being a single-link device, and the measurement report is transmitted by the STA.

Embodiment A4. The first WD of Embodiment A3, wherein the communication measurement is performed by one of the STA, another STA of the first plurality of STAs that is available to perform the communication measurement and is different from the STA, and at least one predetermined STA of the plurality of STAs.

Embodiment A5. The first WD of Embodiment A1, wherein the communication measurement includes one of a single measurement performed on a single communication link and a plurality of measurements, each measurement of the plurality of measurements being performed on a different communication link.

Embodiment A6. The first WD of Embodiment A1, wherein the measurement report is transmitted in one of a single measurement report frame and a plurality of measurement report frames.

Embodiment A7. The first WD of Embodiment A2, wherein the request for the communication measurement is received by the first MLD, the measurement report is transmitted by the first MLD, and the communication measurement is performed by one of an STA, an STA of the first plurality of STAs that is available to perform the communication measurement, and at least one predetermined STA of the plurality of STAs.

Embodiment A8. The first WD of Embodiment A1, wherein processing circuitry is further configured to:
transmit a refusal to perform the communication measurement.

Embodiment B1. A method implemented in a first wireless device (WD) configured to communicate with a second WD, the method comprising:
receiving a request for a communication measurement;
performing the communication measurement based at least on the received request; and
transmitting a measurement report, the measurement report including at least the performed communication measurement.

Embodiment B2. The method of Embodiment B 1, wherein the first WD includes a first multi-link device (MLD), the first MLD including a first plurality of stations (STAs).

Embodiment B3. The method of Embodiment B2, wherein the request for the communication measurement is received by an STA of the first plurality of STAs, the STA being a single-link device, and the measurement report is transmitted by the STA.

Embodiment B4. The first WD of Embodiment B3, wherein the communication measurement is performed by one of the STA, another STA of the first plurality of STAs that is available to perform the communication measurement and is different from the STA, and at least one predetermined STA of the plurality of STAs.

Embodiment B5. The first WD of Embodiment B 1, wherein the communication measurement includes one of a single measurement performed on a single communication link and a plurality of measurements, each measurement of the plurality of measurements being performed on a different communication link.

Embodiment B6. The first WD of Embodiment B1, wherein the measurement report is transmitted in one of a single measurement report frame and a plurality of measurement report frames.

Embodiment B7. The first WD of Embodiment B2, wherein the request for the communication measurement is received by the first MLD, the measurement report is transmitted by the first MLD, and the communication measurement is performed by one of an STA, an STA of the first plurality of STAs that is available to perform the communication measurement, and at least one predetermined STA of the plurality of STAs.

Embodiment B8. The first WD of Embodiment B1, the method further including:
transmitting a refusal to perform the communication measurement.

Embodiment C1. A second wireless device (WD) configured to communicate with a first WD, the second wireless device configured to, and/or comprising a radio interface and/or comprising processing circuitry configured to:
transmit a request for a communication measurement; and
receive a measurement report, the measurement report including at least the communication measurement.

Embodiment C2. The second WD of Embodiment C1, wherein the second WD includes a second multi-link device (MLD), the second MLD including a second plurality of stations (STAs).

Embodiment C3. The second WD of Embodiment C2, wherein the request for the communication measurement is transmitted by an STA of the second plurality of STAs, and the measurement report is received from an STA of the first WD, the STA of the first WD being a single-link device.

Embodiment C4. The second WD of Embodiment C1, wherein the communication measurement includes one of a single measurement performed on a single communication link and a plurality of measurements, each measurement of the plurality of measurements being performed on a different communication link.

Embodiment C5. The second WD of Embodiment C1, wherein the measurement report is received in one of a single measurement report frame and a plurality of measurement report frames.

Embodiment C6. The second WD of Embodiment C2, wherein the request for the communication measurement is transmitted by the second MLD and the measurement report is received by the second MLD.

Embodiment C7. The second WD of Embodiment C1, wherein processing circuitry is further configured to:
receive a refusal to perform the communication measurement.

Embodiment D1. A method implemented in a second wireless device (WD) configured to communicate with a first WD, the method comprising:
transmitting a request for a communication measurement; and
receiving a measurement report, the measurement report including at least the communication measurement.

Embodiment D2. The second WD of Embodiment D1, wherein the second WD includes a second multi-link device (MLD), the second MILD including a second plurality of stations (STAs).

Embodiment D3. The second WD of Embodiment D2, wherein the request for the communication measurement is transmitted by an STA of the second plurality of STAs, and the measurement report is received from an STA of the first WD, the STA of the first WD being a single-link device.

Embodiment D4. The second WD of Embodiment D1, wherein the communication measurement includes one of a single measurement performed on a single communication link and a plurality of measurements, each measurement of the plurality of measurements being performed on a different communication link.

Embodiment D5. The second WD of Embodiment D1, wherein the measurement report is received in one of a single measurement report frame and a plurality of measurement report frames.

Embodiment D6. The second WD of Embodiment D2, wherein the request for the communication measurement is transmitted by the second MLD and the measurement report is received by the second MLD.

Embodiment D7. The second WD of Embodiment D1, the method further including:
receiving a refusal to perform the communication measurement.

1. A first wireless device, WD, configured to communicate with a second WD, the first WD configured to:
receive a request for a measurement;
perform the measurement based at least on the received request;
transmit a measurement report, the measurement report including at least the performed measurement; and
the first WD including a first multi-link device, MLD, the first MLD including a first plurality of stations, STAs.

2. The first WD of claim 1, wherein the request for the measurement is received by an STA of the first plurality of STAs, and the measurement report is transmitted by the STA or another STA of the first plurality of STAs.

3. The first WD of claim 2, wherein the measurement is performed by one of:
the STA;
another STA of the first plurality of STAs that is available to perform the measurement and is different from the STA; and
at least one predetermined STA of the plurality of STAs.

4. The first WD of claim 1, wherein the measurement includes one of:
a single measurement performed on a single communication link; and
a plurality of measurements, each measurement of the plurality of measurements being performed on a different communication link.

5. The first WD of claim 1, wherein the measurement report is transmitted in one of:
a single measurement report frame; and
a plurality of measurement report frames.

6. The first WD of claim 1, wherein the request for the measurement is received by the first MLD, the measurement report is transmitted by the first MLD, and the measurement is performed by one of:
an STA;
an STA of the first plurality of STAs that is available to perform the measurement; and
at least one predetermined STA of the plurality of STAs.

7. The first WD of claim 1, configured to:
transmit a refusal to perform the measurement.

8. A method implemented in a first wireless device, WD, configured to communicate with a second WD, the method comprising:
receiving a request for a measurement;
performing the measurement based at least on the received request;
transmitting a measurement report, the measurement report including at least the performed measurement; and
the first WD including a first multi-link device, MLD, the first MLD including a first plurality of stations, STAs.

9. The method of claim 8, wherein the request for the measurement is received by an STA of the first plurality of STAs, and the measurement report is transmitted by the STA or another STA of the first plurality of STAs.

10. The method of claim 9, wherein the measurement is performed by one of:
the STA;
another STA of the first plurality of STAs that is available to perform the measurement and is different from the STA; and
at least one predetermined STA of the plurality of STAs.

11. The method of claim 8, wherein the measurement includes one of:
a single measurement performed on a single communication link; and
a plurality of measurements, each measurement of the plurality of measurements being performed on a different communication link.

12. The method of claim 8, wherein the measurement report is transmitted in one of:
a single measurement report frame; and
a plurality of measurement report frames.

13. The method of claim 8, wherein the request for the measurement is received by the first MLD, the measurement report is transmitted by the first MLD, and the measurement is performed by one of:
an STA;
an STA of the first plurality of STAs that is available to perform the measurement; and
at least one predetermined STA of the plurality of STAs.

14. The method of claim 8, including:
transmitting a refusal to perform the measurement.

15. A second wireless device, WD, configured to communicate with a first WD, the second WD configured to:
transmit a request for a measurement;
receive a measurement report, the measurement report including at least the measurement; and
the second WD including a second multi-link device, MLD, the second MLD including a second plurality of stations, STAs.

16. The second WD of claim 15, wherein the request for the measurement is transmitted by an STA of the second plurality of STAs, and the measurement report is received from an STA of the first WD.

17. The second WD of claim 15, wherein the measurement includes one of:
a single measurement performed on a single communication link; and
a plurality of measurements, each measurement of the plurality of measurements being performed on a different communication link.

18. The second WD of claim 15, wherein the measurement report is received in one of:
a single measurement report frame; and
a plurality of measurement report frames.

19. The second WD of claim 15, wherein the request for the measurement is transmitted by the second MLD and the measurement report is received by the second MLD.

20. The second WD of claim 15, configured to:
receive a refusal to perform the measurement.

21. A method implemented in a second wireless device, WD, configured to communicate with a first WD, the method comprising:
transmitting a request for a measurement;
receiving a measurement report, the measurement report including at least the measurement; and
the second WD including a second multi-link device, MLD, the second MLD including a second plurality of stations, STAs.

22. The method of claim 21, wherein the request for the measurement is transmitted by an STA of the second plurality of STAs, and the measurement report is received from an STA of the first WD.

23. The method of claim 21, wherein the measurement includes one of:
a single measurement performed on a single communication link; and
a plurality of measurements, each measurement of the plurality of measurements being performed on a different communication link.

24. The method of claim 21, wherein the measurement report is received in one of:
a single measurement report frame; and
a plurality of measurement report frames.

25. The method of claim 21, wherein the request for the measurement is transmitted by the second MLD and the measurement report is received by the second MLD.

26. The method of claim 21, including:
receiving a refusal to perform the measurement.
